(19) United States
(12) Patent Application Publication
(10) Pub. No.: US 2022/0414569 A1
(43) Pub. Date: Dec. 29, 2022

(54) STORE MANAGEMENT SYSTEM, STORE MANAGEMENT METHOD, COMPUTER PROGRAM AND RECORDING MEDIUM

(71) Applicant: NEC CORPORATION, Tokyo (JP)

(72) Inventor: Rina TOMITA, Tokyo (JP)

(73) Assignee: NEC CORPORATION, Tokyo (JP)

(21) Appl. No.: 17/638,473

(22) PCT Filed: Aug. 4, 2020
(86) PCT No.: PCT/JP2020/029851

§ 371 Date: Feb. 25, 2022

(30) Foreign Application Priority Data
Aug. 28, 2019 (JP) 2019-155558

(51) Int. Cl. G06Q 10/06; G06T 7/00

(52) U.S. Cl. CPC G06Q 10/06315; G06T 7/0002

(57) ABSTRACT

A store management system includes: a first setting unit that sets a first priority indicating a degree of priority about a display, for a plurality of display items relating to a store; a second setting unit that sets a second priority that is different from the first priority, on the basis of a captured image of the store; a sorting unit that rearranges the plurality of display items on the basis of the first priority and the second priority; and a display unit that displays the plurality of display items, in order of rearrangement performed by the sorting unit. According to such a store management system, it is possible to appropriately display a plurality of information about the store.

### TECHNICAL FIELD

The present invention relates to a store management system, a store management method, a computer program and a recording medium that manage a store.

### BACKGROUND ART

A known system of this type monitors a situation of a store. For example, Patent Literature 1 discloses a technique/technology of specifying merchandise displayed on a display shelf by capturing an image of the display shelf in a store. Patent Literature 2 discloses a technique/technology of utilizing a predetermined priority for each category of merchandise when monitoring a shortage state of the merchandise. Patent Literature 3 discloses a technique/technology of obtaining an image of a plurality of individual areas set in a store and displaying the image of the individual area in the order of high priority.

As another related technique/technology, Patent Literature 4 discloses a technique/technology of generating and outputting a three-dimensional image in accordance with a display priority. Patent Literature 5 discloses a technique/technology of capturing and displaying an image of a suspicious person.

### CITATION LIST

### Patent Literature

Patent Literature 1: JP2018-170044A
Patent Literature 2: JP2017-162375A
Patent Literature 3: JP2016-018567A
Patent Literature 4: JP2006-288495A
Patent Literature 5: JP2004-208288A

### SUMMARY

### Technical Problem

When managing a store, various information obtained from the captured image of the store may be divided into a plurality of items (e.g., items corresponding to respective merchandise shelves) and displayed on a terminal or the like. These items are displayed, for example, in a list format on a display screen of the terminal, but if there are too many items, some of them may not fit on the screen. Therefore, it is preferable that an item to be immediately confirmed (e.g., an item of high urgency such as a “stockout” or the like) is displayed preferentially than the other items (e.g., is displayed in a higher ranking).

The Patent Literatures 1 to 3 described above disclose the technique/technology of specifying merchandise from the image of the store and the technique/technology of setting priority for each article of merchandise, but even if each item is displayed in the priority set in advance, it is not necessarily optimal order for a user. In other words, each of the above-described Patent Literatures has room for improvement in appropriately displaying a plurality of items.

In view of the problems described above, it is therefore an example object of the present invention to provide a store management system, a store management method, a computer program, and a recording medium that are configured to appropriately displaying a plurality of information about a store.

### Solution to Problem

A store management system according to an example aspect of the present invention includes: a first setting unit that sets a first priority indicating a degree of priority about a display, for a plurality of display items relating to a store; a second setting unit that sets a second priority that is different from the first priority, on the basis of a captured image of the store; a sorting unit that rearranges the plurality of display items on the basis of the first priority and the second priority; and a display unit that displays the plurality of display items, in order of rearrangement performed by the sorting unit.

A store management method according to an example aspect of the present invention includes: a first setting step that sets a first priority indicating a degree of priority about a display, for a plurality of display items relating to a store; a second setting step that sets a second priority that is different from the first priority, on the basis of a captured image of the store; a sorting step that rearranges the plurality of display items on the basis of the first priority and the second priority; and a display step that displays the plurality of display items, in order of rearrangement performed by the sorting step.

A computer program according to an example aspect of the present invention allows a computer to execute: a first setting step that sets a first priority indicating a degree of priority about a display, for a plurality of display items relating to a store; a second setting step that sets a second priority that is different from the first priority, on the basis of a captured image of the store; a sorting step that rearranges the plurality of display items on the basis of the first priority and the second priority; and a display step that displays the plurality of display items, in order of rearrangement performed by the sorting step.

On a recording medium according to an example aspect of the present invention, the computer program described above is recorded.

### Advantageous Effects of Invention

According to the store management system, the store management method, the computer program, and the recording medium in the respective example aspects described above, it is possible to appropriately display a plurality of information about a store.

### BRIEF DESCRIPTION OF DRAWINGS

FIG. 1 is a block diagram illustrating an overall configuration of a store management system according to an example embodiment.

FIG. 2 is a block diagram illustrating a hardware configuration of a store control apparatus according to the example embodiment.

FIG. 3 is a flowchart illustrating a flow of the operation of the store management system according to the example embodiment.

FIG. 4 is a diagram illustrating a display example when a first priority and a second priority are not set.

FIG. 5 is a diagram illustrating a display example when the first priority is set and the second priority is not set.

FIG. 6 is a diagram illustrating a display example when the first priority and second priority are set.

FIG. 7 is a table illustrating an example of a method of setting the second priority in accordance with an abnormality type.

FIG. 8 is a diagram illustrating a display example when interruptedly displaying an alert of suspicious person detection.

FIG. 9 is a diagram illustrating an example of a screen transition flow in an application of the store management system according to the example embodiment.

FIG. 10 is a diagram illustrating an example of a multiple display functions in the application of the store management system according to the example embodiment.

FIG. 11 is a diagram illustrating an example of a store comparison function in the application of the store management system according to the example embodiment.

### DESCRIPTION OF EXAMPLE EMBODIMENTS

Hereinafter, a store management system, a store management method, a computer program, and a recording medium according to an example embodiment will be described with reference to the drawings.

### System Configuration

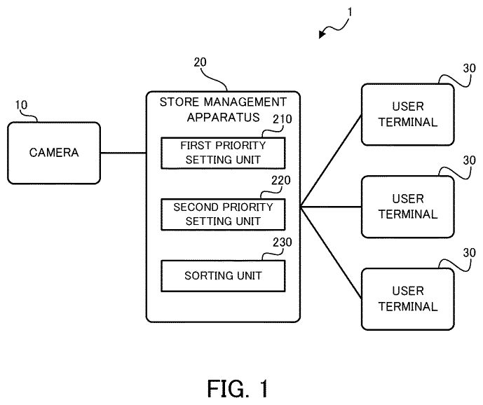

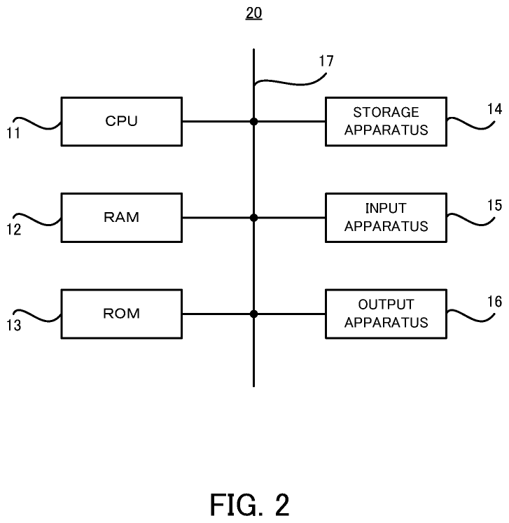

Firstly, a configuration of a store management system according to an example embodiment will be described with reference to FIG. 1 and FIG. 2. FIG. 1 is a block diagram illustrating an overall configuration of the store management system according to the example embodiment. FIG. 2 is a block diagram illustrating a hardware configuration of the store control apparatus according to the example embodiment.

In FIG. 1, a store management system 1 according to the example embodiment is a system applied to a store, such as, for example, a convenience store, and includes a camera 10, a store management apparatus 20, and a plurality of user terminals 30 as main components.

The camera 10 is configured to image the interior of the store or the periphery of the store. The camera 10 may be one that captures a moving image, or may be one that periodically captures a still image at a constant cycle. There may be a plurality of cameras 10 that are installed for one store. Incidentally, the camera 10 is preferably installed so as not to allow blind spots in the store. If a target monitored by the store management system 1 (in other words, a target associated with a display item) is limited, an imaging range may be limited. The captured image captured by the camera is configured to be outputted to the store managing apparatus 20.

The store management apparatus 20 is configured, for example, as a management server. The store management apparatus 20 obtains a plurality of display items relating to the store, from the captured image of the camera 10. The display item is, for example, an item corresponding to each shelf in the store (e.g., “shelf A”, “shelf B”, “shelf C”, etc.). Alternatively, when managing a plurality of stores, the display item may be an item corresponding to each store (e.g., “store A”, “store B”, “store C”, etc.). Incidentally, the store control apparatus 20 may correspond to a plurality of cameras 10. Furthermore, the store management apparatus 20 may correspond to a plurality of stores (in other words, a plurality of cameras 10 installed in the respective stores). The store management apparatus includes a first priority setting unit 210, a second priority setting unit 220, and a sorting unit 230 as logical processing blocks for realizing the functions.

The first priority setting unit 210 is configured to set a first priority for each of the display items relating to the store obtained from the captured image of the camera 10. The “first priority” here is a parameter for determining the display order of the plurality of display items. The first priority may be set in advance, for example, in accordance with a user's operation (in other words, the user may be allowed to arbitrarily set the first priority).

The second priority setting unit 220 is configured to set a second priority for each of the display items relating to the store obtained from the captured image of the camera 10. The “second priority” here is a parameter for determining the display order of the plurality of display items as in the first priority, but is set under a different condition from that of the first priority. Specifically, the second priority is set in accordance with the captured image of the camera 10. For example, the second priority setting unit 220 may set the second priority on the basis of an abnormality detected from the captured image of the camera 10 (e.g., a stockout, a foreign matter, a suspicious person, etc.).

The sorting unit 230 sorts out the plurality of display items relating to the stores obtained from the captured images of the camera 10, on the basis of the first priority set by the first priority setting unit 210 and the second priority set by the second priority setting unit 220. A specific sorting method in the sorting unit 230 will be described in detail later.

As illustrated in FIG. 2, the store management apparatus 20 according to the example embodiment includes a CPU (Central Processing Unit) 11, a RAM (Random Access Memory) 12, a ROM (Read Only Memory) 13, and a storage apparatus 14. The store management apparatus 20 may further include an input apparatus 15 and an output apparatus 16. The CPU 11, the RAM 12, the ROM 13, the storage apparatus 14, the input apparatus 15, and the output apparatus 16 are connected through a data bus 17.

The CPU 11 reads a computer program. For example, the CPU 11 may read a computer program stored by at least one of RAM 12, ROM 13 and the storage apparatus 14. For example, the CPU 11 may read a computer program stored in a computer-readable recording medium, by using a not illustrated recording medium reading apparatus. The CPU 11 may obtain (i.e., read) a computer program from a not-illustrated apparatus located outside the store management apparatus 20, through a network interface. The CPU 11 controls the RAM 12, the storage apparatus 14, the input apparatus 15, and the output apparatus 16 by executing the read computer program. Especially in the example embodiment, when the CPU 11 executes the read computer program, a functional block for rearranging and displaying the plurality of display items is implemented in the CPU 11. The first priority setting unit 210, the second priority setting unit 220, and the sorting unit 230 described above are implemented in this CPU 11, for example.

The RAM 12 temporarily stores the computer program to be executed by the CPU 11. The RAM 12 temporarily stores the data that is temporarily used by the CPU 11 when the CPU 11 executes the computer program. The RAM 12 may be, for example, a D-RAM (Dynamic RAM).

The ROM 13 stores the computer program to be executed by the CPU 11. The ROM 13 may otherwise store fixed data. The ROM 13 may be, for example, a P-ROM (Programmable ROM).

The storage apparatus 14 stores the data that is stored for a long term by the store management system 1. The storage apparatus 14 may operate as a temporary storage apparatus of the CPU 11. The storage apparatus 14 may include, for example, at least one of a hard disk apparatus, a magneto-optical disk apparatus, an SSD (Solid State Drive), and a disk array apparatus.

The input apparatus 15 is an apparatus that receives an input instruction from a user of the store management system 1. The input apparatus 15 may include, for example, at least one of a keyboard, a mouse, and a touch panel.

The output apparatus 16 is an apparatus that outputs information about the store management system 1 to the outside. For example, the output apparatus 16 may be a display apparatus that is configured to display the information about the store management system 1.

Returning to FIG. 1, the user terminal 30 is a terminal possessed by each user of the store management system 1 (e.g., a store manager, a store staff, etc.), and is configured, for example, a personal computer, a tablet, or a smartphone. The user terminal 30 is configured as a terminal that is configured to display a plurality of display items that are sorted out in the store management apparatus 20. The user terminal 30 may be a terminal that is configured to perform an operation for setting the first priority.

### Explanation of Operation

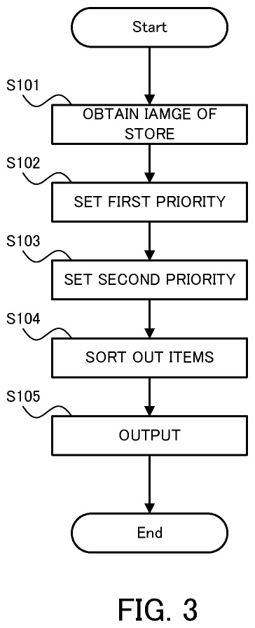

Next, a flow of the operation of the store management system 1 according to the example embodiment will be described with reference to FIG. 3. FIG. 3 is a flowchart illustrating the flow of the operation of the store management system according to the example embodiment.

As illustrated in FIG. 3, in operation of the store management system 1 according to the example embodiment, firstly, the camera 10 obtains an image of the store (step S101). The captured image obtained by the camera 10 is divided so as to correspond to a plurality of display items in the store. In other words, each of the divided captured images is associated with respective one of the display items. For example, an image obtained by imaging a shelf A in the store is associated with a display item “shelf A”. Similarly, an image obtained by imaging a shelf B in the store is associated with a display item “shelf B”.

Subsequently, the first priority setting unit 210 sets the first priority (step S102). The first priority is set, for example, in accordance with the user's operation. The first priority may be set in advance (in other words, before the image is obtained by the camera 10). In this case, the first priority setting unit 210 obtains the first priority by reading the first priority set (or stored) in advance.

Subsequently, the second priority setting unit 220 obtains the second priority (step S103). The second priority is set on the basis of the captured image obtained by the camera 10. Specifically, the second priority is set on the basis of a result of analysis of the captured image corresponding to each display item. For example, the second priority of the display item “shelf A” is set on the basis of the analysis result of an image obtained by capturing the shelf A. Similarly, the second priority of the display item “Shelf B” is set on the basis of the analysis result of an image obtained by capturing the shelf B.

Subsequently, the sorting unit 230 rearranges the plurality of display items on the basis of the first priority and the second priority (step S104). The sorting unit 230 outputs and displays the rearranged display items on the user terminal 30 (step S105). The plurality of items are displayed, for example, in a list format on a display screen of the user terminal 30. At this time, the user may specify a display item, by which the captured image corresponding to the specified display item may be displayed.

A series of operation steps described above may be performed at each time that the captured image is obtained by the camera 10, or may be performed periodically at a predetermined cycle. Alternatively, it may be performed at a time at which the user terminal 30 is turned on or at a time at which the display items are displayed on the user terminal 30.

### Specific Sorting Example

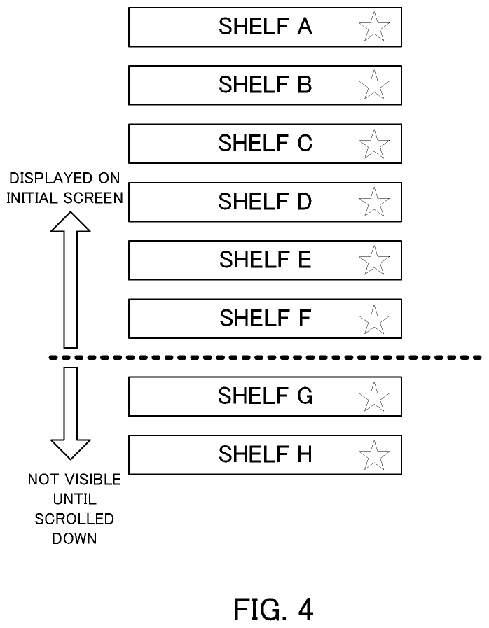

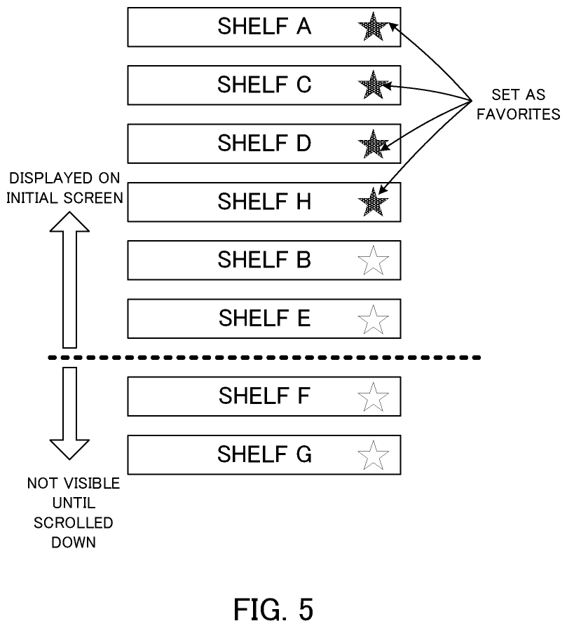

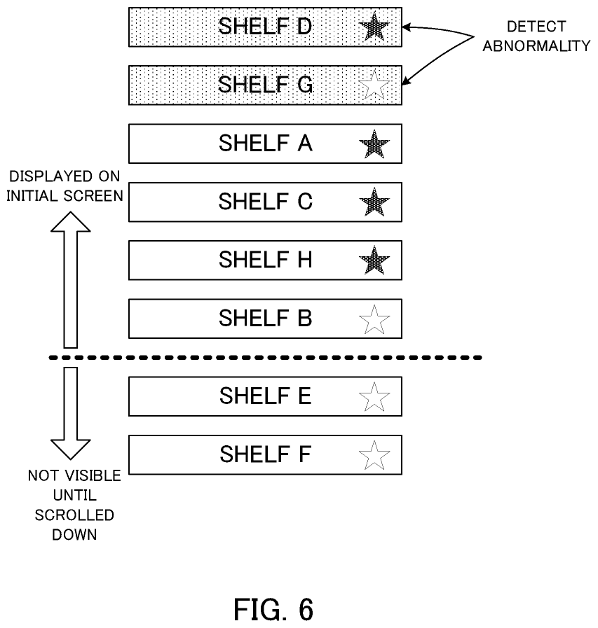

Next, a specific sorting example by the sorting unit 230 will be described with reference to FIG. 4 to FIG. 6. FIG. 4 is a diagram illustrating a display example when the first priority and the second priority are not set. FIG. 5 is a diagram illustrating a display example when the first priority is set and the second priority is not set. FIG. 6 is a diagram illustrating a display example when the first priority and second priority are set. The following describes an example in which display items “shelves A” to “shelves H” corresponding to respective merchandise display shelves in the store are displayed.

FIG. 4 illustrates the display example when the first priority and the second priority are not set (in other words, the first priority and the second priority are in the same state in all the items). When the first priority and the second priority are not set, the items “shelf A” to “shelf H” are sorted out by name (in this case, in alphabetical order). Here, the number of items that can be displayed on the user terminal 30 (that is, the number of items that can be displayed on one screen) is “6”. Therefore, the “shelf A” to the “shelf F” displayed in a higher ranking can be confirmed on an initial screen, but the “shelf G” and the “shelf H” displayed in a lower ranking cannot be confirmed on the initial screen (it cannot be confirmed until scrolled down).

FIG. 5 illustrates the display example when the first priority is set, but the second priority is not set. The first priority here is set by the user performing favorite setting. Specifically, the first priority of the display item set as favorites is set higher than the first priority of the display item that is not set as the favorites. As a result, each item of the “shelf A”, the “shelf C”, the “shelf D” and the “shelf H” that are set as favorites is displayed higher than the “shelf B”, the “shelf E”, the “shelf F” and the “shelf G” that are not set as favorites.

As can be seen by comparing FIG. 4 and FIG. 5, the “shelf H” that is not displayed on the initial screen in FIG. 4 is displayed on the initial screen in FIG. 5. Thus, by setting the first priority by the favorite setting, it is possible to display the item that is intended to be more prominent, in a higher ranking.

FIG. 6 illustrates the display example when the first priority and second priority are set. Specifically, an abnormality is detected from the captured images of the “shelf D” and the “shelf G”, and the second priority of the “shelf D” and the “shelf G” is set higher than the second priority of the other items “shelf A”, “shelf B”, “shelf C”, “shelf E”, “shelf F”, and “shelf H”.

The sorting unit 230 is configured to prioritize the second priority over the first priority when rearranging the display order by using both the first priority and the second priority. In other words, the sorting unit 230 is configured such that the weight of the second priority is larger than the weight of the first priority. Therefore, the “shelf D” in which both the first priority and the second priority are high is displayed on the top, and the “shelf G” in which the first priority is low, but the second priority is high, is displayed on the second top. After that, the “shelf A”, the “shelf C”, and the “shelf H” in which the first priority is high are displayed, and the “shelf E” and the “shelf F” in which both the first priority and the second priority are low, are displayed below them.

As can be seen by comparing FIG. 5 and FIG. 6, the “shelf D” displayed on the third from the top in FIG. 5 is displayed on the top in FIG. 6. Furthermore, the “shelf G” that is not displayed on the initial screen in FIG. 5 is displayed on the second from the top in FIG. 6. Thus, by setting the second priority in accordance with the detected abnormality, it is possible to display the display item of high urgency (i.e., the display item that is to be promptly confirmed by the user) in a higher ranking.

Incidentally, the display item in which the abnormality is detected (i.e., the display item in which the second priority is high) may be highlighted, in addition to being displayed in a higher ranking. Specifically, as illustrated in FIG. 6, the color of the items of “shelf D” and “shelf G” may be changed to a color that is more conspicuous (e.g., red, yellow, etc.) than the other items.

(Example of Setting Second Priority)

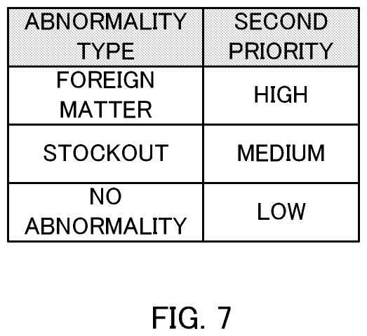

Next, a more specific method of setting the second priority will be described with reference to FIG. 7. FIG. 7 is a table illustrating an example of the method of setting the second priority in accordance with an abnormality type.

As illustrated in FIG. 7, the second priority may be set in accordance with the type of the detected abnormality. Specifically, when a “foreign matter” is detected as the abnormality, the second priority is set “high”. Here, the “foreign matter” is an abnormality that is detected when there exists something that originally should not be on the shelf (e.g., other merchandise or rubbish, etc.). Since such an abnormality has a relatively high urgency, the second priority is set “high” so that the display item is sorted into a position that is noticeable to the user. If a “stockout” is detected as the abnormality, the second priority is set “medium”. The “stockout” here is an abnormality that is detected when the merchandise displayed on the shelf is out of stock or short of stock. Since such an abnormality has a relatively low urgency, the second priority is set “medium” so that the display item is sorted into a position that is slightly more noticeable to the user. If no abnormality is detected, the second priority is set “low” so that the display item is not sorted into a position that is noticeable.

The second priority may be set not only on the basis of the type of the abnormality described above, but also on the basis of an occurrence time and the number of occurrences of the abnormality or the like. Specifically, when the occurrence time of the abnormality is early (in other words, a long time has elapsed from the occurrence), it is considered to be relatively highly urgent, and thus, the second priority may be set high. Alternatively, even when there are a lot of occurrences of the abnormality, it is considered to be relatively highly urgent, and thus, the second priority may be set high.

When using the number of occurrences of the abnormality, in order to avoid detecting the same abnormality many times, a similarity of the abnormality may be determined. Specifically, when the similarity of the detected abnormalities is greater than or equal to a predetermined threshold value, the abnormalities may be treated as being identical. In this way, it is possible to prevent that the second priority becomes unreasonably high because the same abnormality is detected many times. Incidentally, the existing technique/technology can be adopted to determine the similarity of the abnormality. For example, the similarity of the abnormality may be determined by comparing the similarities of the captured images of the camera 10.

(Interruption Display of Alert)

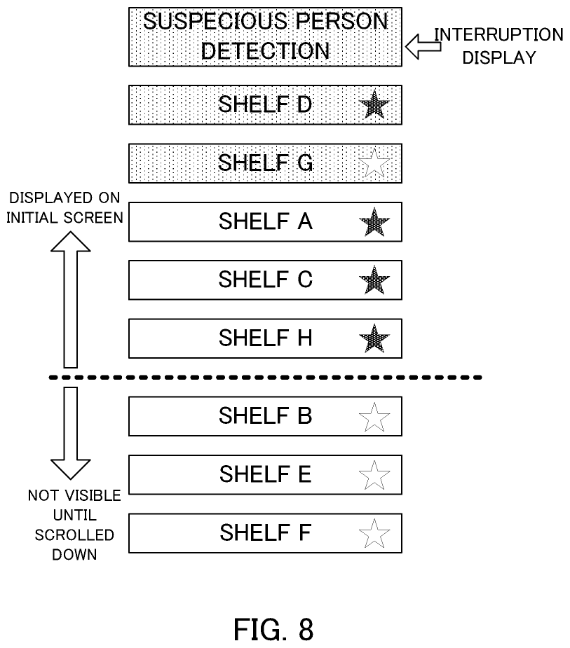

Next, with reference to FIG. 8, a description will be given to an interrupt display of an alert. FIG. 8 is a diagram illustrating a display example when interruptedly displaying an alert of suspicious person detection.

As illustrated in FIG. 8, when a special abnormality is detected, an alert item may be interruptedly displayed, in addition to the display items that are displayed up to that point (i.e., the “shelf A” to the “shelf H”). In the example illustrated in FIG. 8, an alert of “suspicious person detection” is interruptedly displayed on the top. Incidentally, this “suspicious person detection” is an abnormality that is detected when there is a suspicious person in the store. The suspicious person detection is interruptedly displayed as an independent alert item because it is an abnormality that is not related to each item of the merchandise shelf.

Here, the second priority of the alert item of “suspicious person detection” is set to the highest so as to be displayed on the top, but the second priority may be set appropriately in accordance with the type of the abnormality or the like. Therefore, for example, the interruption display may be performed on the second or third position from the top. In addition, when the alert item is interruptedly displayed, if the same abnormality is detected many times, multiple alert items may be interruptedly displayed. For this reason, when the interruption display is performed, it is preferable to perform the above-described similarity determination or the like of the abnormality to prevent the same abnormality from being repeatedly detected many times.

### Technical Effects

Next, technical effects obtained by the store management system 1 according to the example embodiment will be described.

As described in FIGS. 1 to 7, according to the store management system 1 in the example embodiment, it is possible to appropriately rearrange and display a plurality of display items in a store. Especially in the example embodiment, since the two types of priorities set in different conditions (i.e., the first priority and the second priority) are used, it is possible to more appropriately rearrange the display items, as compared with the use of only one type of priority. Therefore, it is possible to present information about the store that is to be informed to the user, in an easy-to-understand display aspect.

<Example of Application of Store Management System>

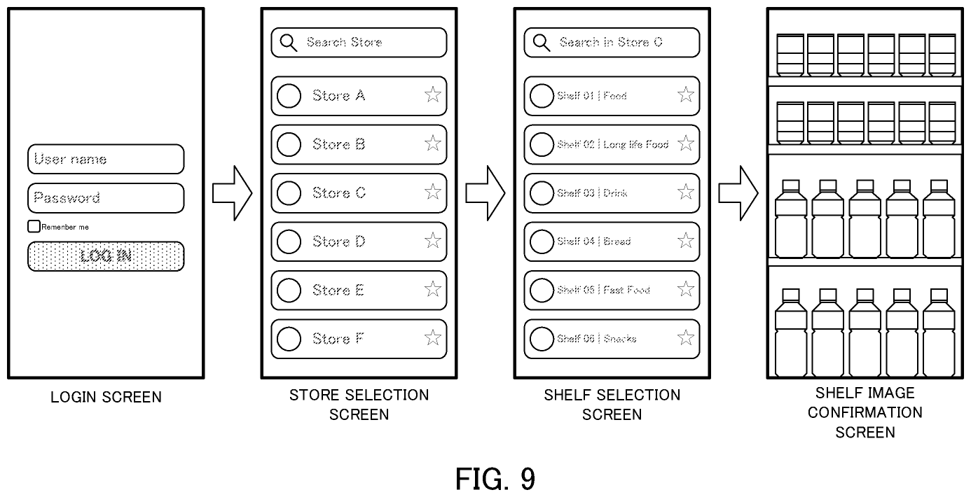

Next, a specific example of an application (e.g., a smartphone application) used when using the store management system 1 according to the example embodiment will be described with reference to FIG. 9 to FIG. 11. It is assumed that such an application is preinstalled, for example, in the user terminal 30 described above, or the like.

(Application Screen Transition Flow)

Firstly, a screen transition flow in an application will be described with reference to FIG. 9. FIG. 9 is a diagram illustrating an example of the screen transition flow in the application of the store management system according to the example embodiment.

As illustrated in FIG. 9, a user who intends to use the store management system 1 enters a preset “user name” and “password” on a login screen to login into the application. Then, a store selection screen including a plurality of store items (here, Store A to Store F) in alignment is displayed on a display of the terminal. Subsequently, when a store is selected (here, a Store C is selected) on the store selection screen, a shelf selection screen including a plurality of shelf items (here, Shelf 01 to Shelf 06) in alignment is displayed. When a shelf is selected (here, a Shelf 03 is selected) on the shelf selection screen, an image of the selected shelf is displayed.

As described above, when using the store management system 1, it is possible to display the shelf image by subsequently selecting the “store” and “shelf” after logging into the application. However, when the store management system 1 is used for only one store, the store selection screen may be omitted and the shelf selection screen may be displayed immediately after login. In the case of the example embodiment, the display items in the store selection screen and the display items in the shelf selection screen may be rearranged (i.e., may be rearranged by using the first priority and second priority).

(Multiple Display Function)

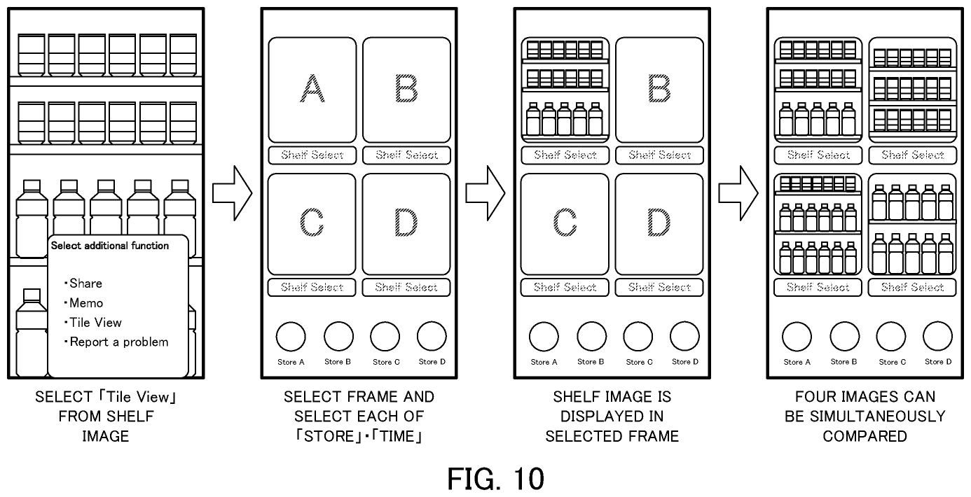

Next, a function of displaying a plurality of images in the application will be described with reference to FIG. 10. FIG. 10 is a diagram illustrating an example of a multiple display function in the application of the store management system according to the example embodiment.

As illustrated in FIG. 10, when “Tile View” is selected from a function panel while the shelf image is displayed, the multiple display function for displaying a plurality of shelf images at the same time can be used. Specifically, when “Tile View” is selected, a plurality of display frames (here, four frames of A to D) are displayed on the screen. After selecting one of these frames and selecting “store” or “time”, the shelf image in the selected time zone of the selected store can be displayed in the selected frame. By selecting “store” and “time” for all the frames in this way, in the end, it is possible to display four shelf images at the same time. This makes it possible to confirm a plurality of shelf images at the same time. Here, although the simultaneous display in four frames of 2×2 is exemplified, the shelf images may be displayed at the same time in different layouts.

By displaying a plurality of shelf images at the same time, for example, it is possible to compare the states of shelves between one store and another store. Thus, it is possible to confirm, for example, a difference in merchandise arrangement with that of an excellent store.

(Store Comparison Function)

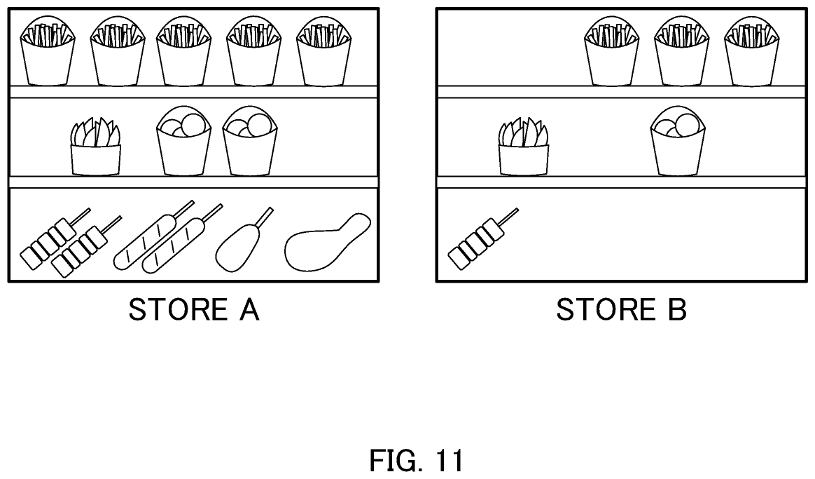

Next, a store comparison function in the application will be described with reference to FIG. 11. FIG. 11 is a diagram illustrating an example of the store comparison function in the application of the store management system according to the example embodiment.

As illustrated in FIG. 11, a function of confirming a difference in merchandise display between stores by displaying the shelf images of two different stores side by side may be provided. For example, by displaying the shelves of Store A and Store B side by side, as illustrated in FIG. 11, it is possible to confirm the merchandise that is short of stock or the merchandise that is sold out. Thus, by arranging the images side by side to allow them to be compared, it is possible to convey the information that is hard to convey by email, telephone, or the like, in an easy-to-understand manner.

<Supplementary Notes>

With respect to the example embodiment described above, the following Supplementary Notes will be further disclosed.

(Supplementary Note 1)

A store management system described in Supplementary Note 1 is a store management system including: a first setting unit that sets a first priority indicating a degree of priority about a display, for a plurality of display items relating to a store; a second setting unit that sets a second priority that is different from the first priority, on the basis of a captured image of the store; a sorting unit that rearranges the plurality of display items on the basis of the first priority and the second priority; and a display unit that displays the plurality of display items, in order of rearrangement performed by the sorting unit.

(Supplementary Note 2)

A store management system described in Supplementary Note 2 is the store management system described in Supplementary Note 1, wherein the sorting unit rearranges the plurality of display items by increasing a weight of the second priority than that of the first priority.

(Supplementary Note 3)

A store management system described in Supplementary Note 3 is the store management system described in Supplementary Note 1 or 2, wherein the first setting unit sets the first priority in accordance with an operation by a user.

(Supplementary Note 4)

A store management system described in Supplementary Note 4 is the store management system described in Supplementary Note 3, wherein the first setting unit sets the first priority of an item that is selected by the user from among the plurality of display items, to be higher than the first priority of an item that is not selected by the user.

(Supplementary Note 5)

A store management system described in Supplementary Note 5 is the store management system described in any one of Supplementary Notes 1 to 4, wherein the second setting unit detects an abnormality in the store from the captured image, and sets the second priority of an item that is related to the abnormality among the plurality of display items, to be higher than the second priority of an item that is not related to the abnormality.

(Supplementary Note 6)

A store management system described in Supplementary Note 6 is the store management system described in Supplementary Note 5, wherein the second setting unit sets the second priority on the basis of at least one of a type of the abnormality, an occurrence time, and number of occurrences.

(Supplementary Note 7)

A store management system described in Supplementary Note 7 is the store management system described in Supplementary Note 5 or 6, wherein the second setting unit compares similarities of abnormalities detected from the captured image and treats the abnormalities as being identical when each of the similarities is greater than or equal to a predetermined threshold value.

(Supplementary Note 8)

A store management system described in Supplementary Note 8 is the store management system described in any one of Supplementary Notes 1 to 7, wherein the plurality of display items are items corresponding to respective display shelves in the store.

(Supplementary Note 9)

A store management method described in Supplementary Note 9 is a store management method including: a first setting step that sets a first priority indicating a degree of priority about a display, for a plurality of display items relating to a store; a second setting step that sets a second priority that is different from the first priority, on the basis of a captured image of the store; a sorting step that rearranges the plurality of display items on the basis of the first priority and the second priority; and a display step that displays the plurality of display items, in order of rearrangement performed by the sorting step.

(Supplementary Note 10)

A computer program described in Supplementary Note 10 is a computer program that allows a computer to execute: a first setting step that sets a first priority indicating a degree of priority about a display, for a plurality of display items relating to a store; a second setting step that sets a second priority that is different from the first priority, on the basis of a captured image of the store; a sorting step that rearranges the plurality of display items on the basis of the first priority and the second priority; and a display step that displays the plurality of display items, in order of rearrangement performed by the sorting step.

(Supplementary Note 11)

A recording medium described in Supplementary Note 11 is a recording medium on which the computer program described in Supplementary Note 10 is recorded.

The present invention is not limited to the examples described above and is allowed to be changed, if desired, without departing from the essence or spirit of the invention which can be read from the claims and the entire specification. A store management system, a store management method, a computer program and a recording medium with such changes are also intended to be within the technical scope of the present invention.

To the extent permitted by law, this application is based upon and claims the benefit of priority from Japanese Patent Application No. 2019-155558, filed Aug. 28, 2019, and incorporates all of its disclosure herein. Also, to the extent permitted by legislation, all the publications and articles described in the description are incorporated herein by reference.

### DESCRIPTION OF REFERENCE CODES

1 Store management system
10 Camera
20 Store control apparatus
30 User terminal
210 First priority setting unit
220 Second priority setting unit
230 Sorting unit

1. A store management system comprising:
at least one memory that is configured to store informations; and
at least one processor that is configured to execute instructions
to set a first priority indicating a degree of priority about a display, for a plurality of display items relating to a store,
to set a second priority that is different from the first priority, on the basis of a captured image of the store,
to rearranges the plurality of display items on the basis of the first priority and the second priority, and
to display the plurality of display items, in order of rearrangement performed by the sorting unit.

2. The store management system according to claim 1, wherein the processor rearranges the plurality of display items by increasing a weight of the second priority than that of the first priority.

3. The store management system according to claim 1, wherein the processor sets the first priority in accordance with an operation by a user.

4. The store management system according to claim 3, wherein the processor sets the first priority of an item that is selected by the user from among the plurality of display items, to be higher than the first priority of an item that is not selected by the user.

5. The store management system according to claim 1, wherein the processor detects an abnormality in the store from the captured image, and sets the second priority of an item that is related to the abnormality among the plurality of display items, to be higher than the second priority of an item that is not related to the abnormality.

6. The store management system according to claim 5, wherein the processor sets the second priority on the basis of at least one of a type of the abnormality, an occurrence time, and number of occurrences.

7. The store management system according to claim 5, wherein the second setting unit compares similarities of abnormalities detected from the captured image and treats the abnormalities as being identical when each of the similarities is greater than or equal to a predetermined threshold value.

8. The store management system according to claim 1, wherein the plurality of display items are items corresponding to respective display shelves in the store.

9. A store management method comprising:
setting a first priority indicating a degree of priority about a display, for a plurality of display items relating to a store;
setting a second priority that is different from the first priority, on the basis of a captured image of the store;
rearranging the plurality of display items on the basis of the first priority and the second priority; and
displaying the plurality of display items, in order of rearrangement performed by the sorting step.

10. A non-transitory recording medium on which azo computer program that allows a computer to execute a store management method,
the store management method including:
setting a first priority indicating a degree of priority about a display, for a plurality of display items relating to a store;
setting a second priority that is different from the first priority, on the basis of a captured image of the store;
rearranging the plurality of display items on the basis of the first priority and the second priority; and
displaying the plurality of display items, in order of rearrangement performed by the sorting step.

11. (canceled)
